(19) United States
(12) Patent Application Publication
(10) Pub. No.: US 2021/0156288 A1
(43) Pub. Date: May 27, 2021

(54) removable scrubber for diesel engine exhaust

(71) Applicant: James Andrew Bentley, Juliette, GA (US)

(72) Inventor: James Andrew Bentley, Juliette, GA (US)

(21) Appl. No.: 16/698,778

(22) Filed: Nov. 27, 2019

(51) Int. Cl. F01N 3/08; B01D 53/14; B01D 53/18; B01D 53/92; B01D 53/48

(52) U.S. Cl. CPC F01N 3/0871; F01N 3/085; B01D 53/1493; B01D 2252/30; B01D 53/92; B01D 53/48; B01D 53/18

(57) ABSTRACT

This device is a removable scrubber for diesel engine exhaust.

It is a fiber glass canister filled with a lime slurry and used in conjunction with a check valve to force diesel engine exhaust through the slurry precipitating gypsum cleaning the impurities out of exhaust.

### BACKGROUND

The scrubber will be a removable fiber glass canister filled with a lime slurry inside positioned on the exhaust side of the engine. The exhaust will be pushed through the canister by help of a turbo ram positioned at the bottom of canister. The exhaust will be pushed through a lime slurry in the canister. As the exhaust is pushed through the slurry it will precipitate gypsum helping to clean the exhaust taking out impurities.

### SUMMARY

The scrubber will be a removable fiber glass canister filled with a lime slurry used to scrub out impurities from diesel exhaust.

### BRIEF DESCRIPTION OF DRAWING

In the following detailed portion of the present description, the teachings of the present application will be explained in more detail with reference to the example embodiments shown in the drawings, in

FIG. 1 is an asymmetric view of the canister, slurry, check valve, and turbo ram according to the first embodiment.

### DETAILED DESCRIPTION

The following is a detailed description of the removable scrubber for diesel engine exhaust.

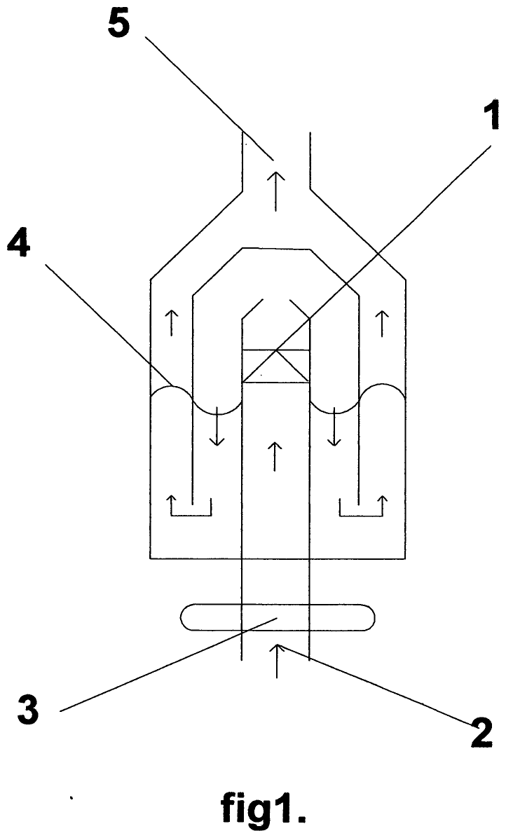

FIG. 1 Number1 is a description of the check valve used to prevent the slurry from backing up into the engine.

FIG. 1 Number2 is a description of the intake side of the canister allowing exhaust to flow into canister.

FIG. 1 Number3 is a description of the turbo ram used to force the exhaust through the slurry so that the canister isn't predatory on the engine, causing the engine to lose power because of the extra back pressure caused by the canister.

FIG. 1 Number4 is a description of the lime slurry housed in the canister. The exhaust will be forced through the lime slurry precipitating gypsum helping to scrub out impurities in the exhaust.

FIG. 1 Number5 is a description of the exhaust side of the canister allowing the clean exhaust to escape from the canister out into the atmosphere.

1. This device is a removable scrubber for diesel engine exhaust. The device is a fiber glass canister filled with a lime slurry and uses a turbo ram in conjunction with a check valve to force diesel engine exhaust through the slurry precipitating gypsum cleaning the impurities out of exhaust.
It will be connected to the exhaust side of the diesel engine. It will be removable so that when the gypsum fills up inside you can take it out and recycle the gypsum and insert a new canister with fresh lime slurry inside.

2. although a diesel engine was used in the example it can be used for any other combustion engine also.
